(19) United States
(12) Patent Application Publication
(10) Pub. No.: US 2016/0271779 A1
(43) Pub. Date: Sep. 22, 2016

(54) Handheld Machine Tool

(71) Applicant: HILTI AKTIENGESELLSCHAFT, Schaan (LI)

(72) Inventors: Markus HARTMANN, Mauerstetten (DE); Aaron WIEDNER, Landsberg (DE); Manuel SERF, Stutensee (DE); Eduard PFEIFFER, Halblech (DE)

(73) Assignee: Hilti Aktiengesellschaft, Schaan (LI)

(21) Appl. No.: 15/035,713

(22) PCT Filed: Nov. 4, 2014
(86) PCT No.: PCT/EP2014/073652

§ 371 Date: May 10, 2016

(30) Foreign Application Priority Data
Nov. 11, 2013 (EP) 13192257.7

(51) Int. Cl. B25D 11/12; B25D 17/24

(52) U.S. Cl. CPC B25D 11/125; B25D 17/245; B25D 2250/035; B25D 2250/185; B25D 2250/231; B25D 2250/245

(57) ABSTRACT

A handheld machine tool is disclosed. The tool has a tool receiving area and a striking mechanism. The striking mechanism contains a striker, an exciter, and a pneumatic chamber. The striker strikes an intermediate striker at the strike point. The exciter is driven between a first dead center at a distance from the strike point and a second dead center in the vicinity of the strike point. A housing, which is encapsulated in an air-tight manner, has an interior which is closed by an exciter end face facing away from the striker. The interior is connected to the pneumatic chamber by a first valve which can be closed by the striker and by a second valve which can be closed by the exciter. The first valve is arranged in the vicinity of the strike point and the second valve is arranged in the vicinity of the first dead center.

This application claims the priority of International Application No. PCT/EP2014/073652, filed Nov. 4, 2014, and European Patent Document No. 13192257.7, filed Nov. 11, 2013, the disclosures of which are expressly incorporated by reference herein.

### BACKGROUND AND SUMMARY OF THE INVENTION

The present invention relates to a handheld machine tool, which is provided with. a motor-driven pneumatic striking mechanism.

EP2130651A1 shows a hammer drill with the generic pneumatic striking mechanism. A motor drives an exciter piston in a guide tube by means of an eccentric wheel. A striker that is likewise arranged in the guide tube is coupled to the movement of the exciter piston by the pneumatic spring configured between the exciter piston and the striker in the form a pneumatic chamber. The striker thereby periodically strikes a largely stationary intermediate striker in the strike direction, which transfers the percussive impulse to a tool.

The pneumatic striking mechanism exerts only small force peaks on the user as compared to a mechanical striking mechanism, because the striker is only weakly coupled to the exciter during striking via the pneumatic spring. During the initial acceleration of the striker by the exciter in the strike direction, however, the pneumatic spring is highly compressed and thereby strongly coupled, which is why this phase is felt by the user.

The handheld machine tool according to the invention has a tool receiving area for receiving a chiseling tool on a work axis, a motor, and a striking mechanism. The striking mechanism contains a striker which is guided on the work axis, an exciter which is periodically driven by the motor, and a pneumatic chamber for coupling the movement of the striker to the periodic movement of the exciter. The striker strikes the tool or an intermediate striker in a strike direction at the strike point. The exciter is driven between a first dead center at a distance from the strike point and a second dead center in the vicinity of the strike point. The pneumatic chamber is formed between the striker and an exciter end face facing the striker. A housing, which is encapsulated in an air-tight manner, has an interior which is closed by an exciter end face facing away from the striker. The interior is connected to the pneumatic chamber by a first valve which can he closed by the striker. Additionally, the interior is connected to the pneumatic chamber by a second valve which can he closed by the exciter. The first valve is arranged in the vicinity of the strike point, and the second valve is arranged in the vicinity of the first dead center.

The interior is considerably larger than the pneumatic chamber, and for example the housing contains the entire gear or parts thereof, e.g., an eccentric wheel. The exciter generates with its reverse side a small, but present, pressure fluctuation as compared to the pneumatic chamber. It was found that this can he used in order to be able to reduce the retroactive force peak that occurs during the initial acceleration phase.

The pressure in the pneumatic chamber is increased by the pressure compensation between the interior and the pneumatic chamber, when the second valve is opened. Due to the arrangement, the valve opens when the exciter is in the vicinity of the first dead center. During operation, the pressure in the interior is increased slightly, and reduced in the pneumatic chamber. The short-term aeration here provides for an increase in the pressure in the pneumatic spring and extends the duration of the coupling of the striker to the exciter. The exciter can accelerate the striker over a longer period of time, thereby reducing the force peaks.

The deaeration of the pneumatic chamber takes place when the striker is in the vicinity of the strike point. Control is accomplished by the striker so that start-up of the striking mechanism is possible after a few cycles of the exciter.

### BRIEF DESCRIPTION OF THE DRAWINGS

FIG. 1 illustrates a hammer drill;

FIGS. 2 and 3 illustrate a pneumatic striking mechanism in two phases;

FIG. 4 illustrates movement of a striker and an exciter of the striking mechanism; and

FIG. 5 illustrates air exchange between a pneumatic chamber of the striking mechanism and an air-tight housing.

### DETAILED DESCRIPTION OF THE DRAWINGS

Unless otherwise indicated, the same or functionally equivalent elements are identified by the same reference numbers in the Figures.

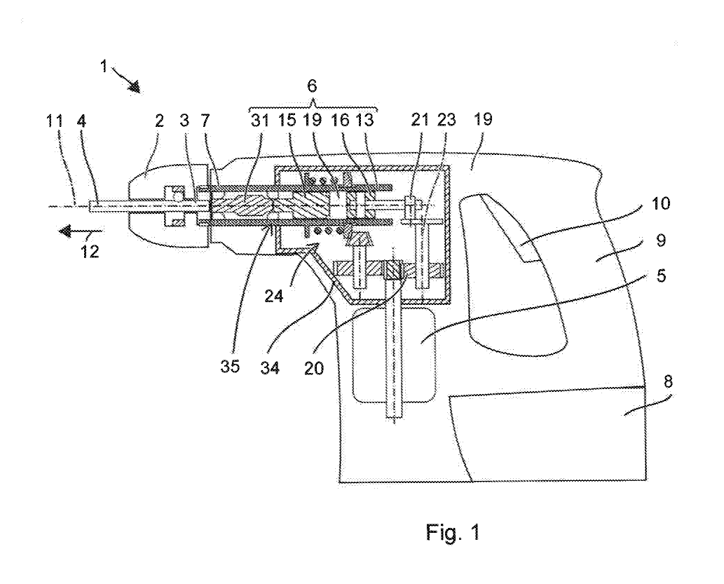

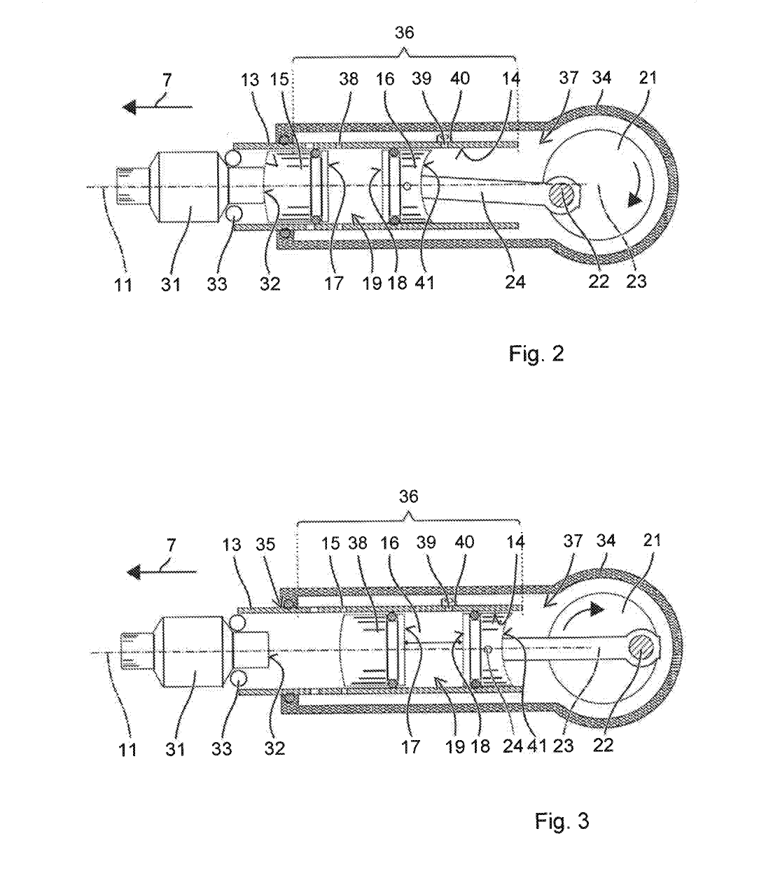

FIG. 1 shows a schematic of a hammer drill 1 as an example of a chiseling handheld machine tool. The hammer drill 1 has a tool receiving area 2, in which a shaft end 3 of a tool, e.g., a chiseling drill 4, can be inserted. A primary drive of the hammer drill 1 is formed by a motor 5, which drives a striking mechanism 6 and an output shaft 7. The electric motor 5 is energized by a battery 8 for example. A user is able to guide the hammer drill 1 by means of a hand grip 9 and put the hammer drill 1 into operation by means of a system switch 10. During operation, the hammer drill 1 rotates the drill 4 continuously around a work axis 11 and can thereby drive the boring tool 4 into a substrate in the strike direction 12 along the work axis 11.

The striking mechanism 6 is a pneumatic striking mechanism 6. The exemplary striking mechanism 6 has a guide tube 13 with a cylindrical inner wall 14. The guide tube 13 is on the work axis 11. A striker 15 is inserted in guide tube 13 and is movable therein along the work axis 11. The striker 15 is configured as a piston, which terminates in an air-tight manner with the inner wall 14. An exciter 16 is arranged in the strike direction 12 in front of the striker 15 in the guide tube 13. The exemplary exciter 16 is likewise configured as a piston, which terminates in an air-tight manner in the guide tube 13 along the work axis 11 movably with the inner wall 14. The striker 15 and the exciter 16 enclose a pneumatic chamber 19 between each other with their facing end faces 17, 18. The pneumatic chamber 19 serves as a pneumatic spring, which couples a movement of the striker 15 to a movement of the exciter 16.

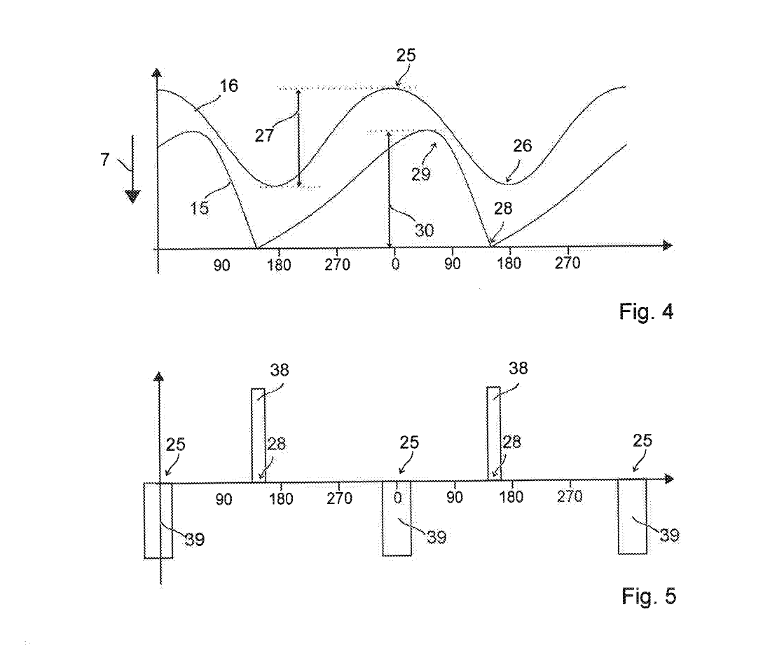

The exciter 16 is coupled to a motor 5 via a gear 20. The gear 20 includes for example an eccentric wheel 21, which converts the rotational movement of the motor 5 into a linear movement of the exciter 10. The eccentric wheel 21 has a finger 22, which is eccentrically offset by a crank radius from an axis of rotation 23 of the eccentric wheel 21. An end of a connecting rod 24 engages around the finger 22 and is suspended with another end in the exciter 16 in a rotatable or swivelable manner. The exciter 16 is forcibly excited to a periodic movement, which runs along the work axis 11 between a first dead center 25 and a second dead center 26 (FIG. 4). The first dead center 25 lies in the strike direction 12 in front of the second dead center 26. The stroke height 27 between the two dead centers 25, 20 is substantially predetermined by the crank radius. instead of an eccentric wheel 21, a wobble finger can also be used, which moves the exciter 16 between the dead centers 25, 26. The gear 20 can include reduction stages, torque clutches, etc.

Coupled to the pneumatic chamber 19, the striker 15 follows the movement of the exciter 16. The movement of the striker 15 and the exciter 16 along the work axis 11 is depicted in FIG. 4. The y-axis indicates the position of the striker 15 and exciter 16 depicted over the angular position of the eccentric wheel 21 on the x-axis. The striker 15 and the exciter 16 are in an abstracted form for the description of their movement or position on a thin disc.

The striker 15 moves periodically in the strike direction 12 up to the strike point 28 and against the strike direction 12 up to a reversal point 29. The distance from the strike point 28 to the reversal point 29 is called the flight distance 30 in the following. At the strike point 28, the striker 15 strikes an intermediate striker 31, which defines the strike point 28 of the striking mechanism 6 with its striking surface 32 that faces the striker 15. The intermediate striker 31 abuts a limit stop 33 against the strike direction 12. The reversal point 29 is approximately in the center between the first dead center 25 and the second dead center 26 of the exciter 16.

The gear 20, in particular the eccentric wheel 21, is arranged in a housing 34. The housing 34 has an opening 35, in which a gear-side section 36 of the striking mechanism 6 is arranged in a flush manner. The guide tube 13 is open in the housing 34 on the gear-side, preferably with the cross-section of the exciter 16. Therefore, the exciter 16 forms at least a portion of the closure for the opening 35. The moved exciter 16 periodically reduces the interior 37 of the housing 34. The housing 34 is encapsulated in an air-tight manner. The pressure in the housing 34 changes with the striking frequency, which is typically in a range between 10 Hz and 100 Hz. The pressure is increased when the exciter 16 is moved forward the furthest in the housing 34, therefore the furthest away from the strike point 28 (first dead center 25). The volume enclosed between the housing 34 and the exciter 16 is between 0.7 times and 5 times the volume covered by the exciter 16. The volume enclosed by the housing 34 and the exciter 16 can increase between 20% and 150% with a cycle of the exciter 16. Leaks must be reduced enough that they cannot achieve any substantial pressure compensation with the environment within a few seconds.

The guide tube 13 is provided with a first valve 38, which connects the pneumatic chamber 19 to the interior 37 of the housing 34. The first valve 38 preferably consists of a radial valve opening in the guide tube 13, which is run over by the striker 15 and thereby covered. The striker 15 releases the valve opening of the valve 38, when the striker 15 is in the vicinity of the strike point 28. The valve opening of the valve 38 is preferably at a distance of less than 10% of the flight distance of the striker 15 from the strike point 28. Therefore, the first valve 38 is closed most of the time during the periodic movement. The housing 34 can cover the first valve 38 along the work axis 11 such that the first valve 38 is inside the interior 37. Alternatively, a tube or another channel can lead from the first valve 38 to the interior 37.

The guide tube 13 is provided with a second valve 39, which connects the pneumatic chamber 19 to the interior 37 of the housing 34. The second valve 39 has a radial valve opening in the guide tube 13, which is run over by the exciter 16 and thereby covered. The exciter 16 releases the valve opening, when the exciter 16 is in the vicinity of the first dead center 25, i.e., in the position removed from the strike point 28. The valve opening of the valve 39 is preferably at a distance of less than 10% of the stroke height 27 from the first dead center 25. The housing 34 can likewise cover the second valve 39, or the second valve 39 is connected to the interior 37 by means of another channel. The second valve 39 can include a non-return valve 40, which prevents an outflow from the pneumatic chamber 19 into the interior 37.

The first valve 38 and the second valve 39 are opened independently at different points in time, and the striker 15 controls only the first valve 38 and the exciter 16 controls only the second valve 39. However, both valves 38, 39 connect the pneumatic chamber 19 to the same interior 37. While the second valve 39 opens, the exciter 16 is in the vicinity of the first dead center 25. The pressure in the housing 34 is increased, at least higher than the pressure in the pneumatic chamber 19. An air quantity flows out of the interior 37 into the pneumatic chamber 19. FIG. 5 schematically shows the air flow plotted on the y-axis over the angular position of the eccentric wheel 21 plotted on the x-axis. While the first valve 38 is opened, the striker 15 has almost reached its final speed. The pressure in the pneumatic chamber 19 is still somewhat higher than in the interior 37, and the previously supplied air quantity flows out.

1.-6. (canceled)

7. A handheld machine tool, comprising:
a tool receiving area, wherein a chiseling tool is receivable in the tool receiving area on a work axis;
a striking mechanism which includes a guide tube coaxial to the work axis, a striker which is guided on the work axis and which strikes an intermediate striker at a strike point, an exciter which is periodically driven between a first dead center at a distance from the strike point and a second dead center in a vicinity of the strike point, and a pneumatic chamber for coupling a movement of the striker to the periodic movement of the exciter, wherein the pneumatic chamber is disposed between the striker and an end face of the exciter that faces the striker;
a housing which is encapsulated in an air-tight manner, wherein an interior of the housing is closed by an end face of the exciter that faces away from the striker;
a first valve which is closable by the striker and is disposed in the vicinity of the strike point, wherein the first valve connects the pneumatic chamber to the interior of the housing; and
a second valve which is closable by the exciter and is disposed in a vicinity of the first dead center, wherein the second valve connects the pneumatic chamber to the interior of the housing.

8. The handheld machine tool according to claim 7, wherein the first valve is only closed if the striker is displaced from the strike point by more than 10% of a flight distance from the strike point to a reversal point of the striker and wherein the second valve is only closed if the exciter is at a distance from the first dead center of more than 10% of a stroke height from the first dead center to the second dead center.

9. The handheld machine tool according to claim 7, wherein the housing contains at least a portion of a gear mechanism.

10. The handheld machine tool according claim 7, wherein the housing defines an opening which is covered by the exciter.

11. The handheld machine tool according to claim 7, wherein the first valve is a radial valve opening in the guide tube and wherein the second valve is a radial valve opening in the guide tube.

12. The handheld machine tool according to claim 11, wherein the first valve and the second valve are disposed inside the housing.
